(19) United States
(12) Patent Application Publication
(10) Pub. No.: US 2003/0025972 A1
(43) Pub. Date: Feb. 6, 2003

(54) Multi-channel laser driver with individually programmable channels

(75) Inventors: Jan During, Huddinge (SE); Tony Lindh, Upplands Vasby (SE)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor AB, Jarfalla (SE)

(21) Appl. No.: 10/195,628

(22) Filed: Jul. 15, 2002

(30) Foreign Application Priority Data
Jul. 21, 2001 (GB) 0117835.9

(51) Int. Cl. H04B 10/04

(52) U.S. Cl. 359/187; 359/180

(57) ABSTRACT

A system and method for individually controlling channels of a multi-channel optical communications system are described. The optical communications system uses optical transmitters such as semi-conductor lasers for each channel. A drive circuit provides energizing energy to each laser in order to generate a modulated output. In the present invention a programmable memory such as an EPROM is used to individually control drive conditions for each laser in order to tailor the output.

### FIELD OF THE INVENTION

This invention relates to an array of optical transmitters for a multi-channel communication system and more particularly to a programmable controller for individually controlling the parameters of each channel.

### BACKGROUND

Optical communications systems typically employ semiconductor diodes or lasers as the transmitter. An example of such a device is a vertical cavity surface emitting laser (VCSEL).

Semiconductor lasers, including VCSELs, are operated above a threshold level which requires that a bias be applied to the device in order to maintain the laser in a lasing mode. When in the lasing mode a modulating RF signal is applied to the device centered about a set modulation current. This provides a modulated optical output signal.

Lasers such as VCSELs tend to have inconsistent electrical to optical conversion characteristics from device to device and therefore require monitoring and parameter adjustments in order to control the optical output. Additionally, the operating temperature both internal and external of the laser has significant influence on the optical characteristics of the laser.

Although it is relatively straight forward to control the output of a single channel optical transmitter it is more difficult to control the output of an array of lasers used in a multi-channel configuration so that the output levels of each are generally equal.

In operation, a driver circuit is provided to supply the necessary voltage and current for the various inputs such as bias current, and modulation current. Typically, a single driver is used for an array of optical transmitters (VCSELs) and the parameters of each of the transmitters are controlled from the single driver. Since the electro-optical characteristics of each device may be slightly different or as each device in the array may be operating at a slightly different temperature it is difficult to predict that the output of each channel will be able to maintain the same output level.

Accordingly, there is a need to have an array of devices for a multi-channel communication system wherein each channel is individually programmed and/or controlled.

### SUMMARY OF THE INVENTION

Therefore, in accordance with the present invention there is a provided, in a first aspect, an array of indivdually controllable optical transmitters for a multichannel communications system. The array comprises a plurality of transmitters, a driver circuit for providing input power to each of the transmitters and a programmable controller for individually controlling input settings to each of the optical transmitter.

In a preferred embodiment the optical transmitters are vertical cavity surface emitting lasers and the programmable controller is an erasable programmable read only memory (EPROM).

In accordance with a second aspect of the present invention there is provided a method of individually controlling optical transmitters in a multi-channel communication system. The method comprises: providing a plurality of optical transmitters, providing input power to each of the optical transmitters utilizing a driver circuit and individually controlling input parameters to each of the optical transmitters utilizing a programmable controller.

### BRIEF DESCRIPTION OF THE DRAWINGS

The invention will now be described in greater detail with reference to the attached FIGURE which is a block diagram of a multi-channel VCSEL driver with individually programmable channels.

### DETAILED DESCRIPTION OF THE INVENTION

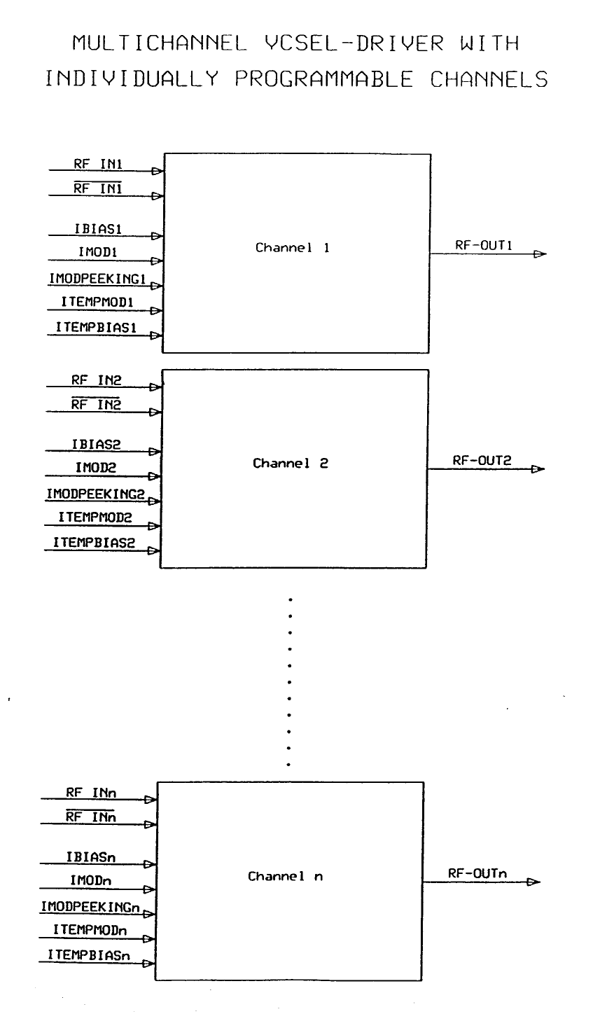

As shown in FIG. 1 the multi-channel array includes channels 1 through n where each receives individual RF input and delivers a modulated RF output therefrom. In prior art devices it is only possible to program an array of channels but not individual channels within the array. Since the performance of the optical transmitters will likely differ within an array it is preferable or even in some instances necessary to be able to program each channel individually. This is particularly true in a high speed application.

According to this invention each of the channels can be set or programmed individually.

As shown in FIG. 1 the input characteristics, which are monitored and indeed which may be programmed for each array, include the bias current, the modulation current, the peak modulation current, the modulation current temperature and the bias current temperature.

According to the invention a programmable memory such as an erasable programmable read only memory (EPROM) is used to control one or more of the above parameters as required. The EPROM can be either integrated with the driver circuit or as a separate chip and interconnected to the driver chip.

The settings which are controlled by the EPROM include a number of values which are proportional to the output current from the driver. The drive current which feeds each individual VCSEL may need to be varied because of, for example, a change in temperature for the individual VCSEL. Accordingly to one embodiment the temperature of the device is monitored by a temperature sensor located at or approximate to the VCSEL. Alternatively, the drive current can be altered intentionally in order that it provide an output that is consistent with the output of an adjacent or other device in the array. As noted previously, the electro-optical characteristics of each device can be different relative to each other and it is therefore important to be able to control each device separately in order to achieve a uniform optical output from the complete array.

While particular embodiments of the invention have been described and illustrated it will be apparent to one skilled in the art that numerous changes can be made to the basic concept. It is to be understood, however, that such changes will fall within the full scope of the invention as defined by the appended claims.

1. An array of individually controllable optical transmitters for a multi-channel communications system comprising;
a plurality of integrated optical transmitters;
a driver circuit for providing input power to each of said optical transmitters; and
a programmable controller for individually controlling input settings to each of said optical transmitters.

2. An array as defined in claim 1 wherein said optical transmitters are vertical cavity surface emitting lasers (VCSELs).

3. An array as defined in claim 2 wherein said programmable controller is an erasable, programmable read only memory (EPROM).

4. An array as defined in claim 3 wherein said EPROM is integrated with said driver circuit.

5. An array as defined in claim 4 wherein said input settings include a plurality of parameters.

6. An array as defined in claim 5 wherein one of said parameters is bias current.

7. An array as defined in claim 5 wherein one of said parameters is modulation current.

8. An array as defined in claim 5 wherein one of said parameters is peak current to said VCSEL.

9. An array as defined in claim 5 wherein at least one of said parameters is set based on VCSEL temperature.

10. An array as defined in claim 9 wherein said VCSEL temperature is measured using a temperature sensor located adjacent said VCSEL.

11. An array as defined in claim 5 wherein at least one of said parameters is set to correspond to a setting of another optical transmitter in said array.

12. A method of individually controlling optical transmitters in a multi-channel communications system comprising;
providing a plurality of integrated optical transmitters;
providing input power to each of said optical transmitters utilizing a driver circuit; and
individually controlling input settings to each of said optical transmitters utilizing a programmable controller.
